(19) United States
(12) Patent Application Publication
(10) Pub. No.: US 2012/0002801 A1
(43) Pub. Date: Jan. 5, 2012

(54) Subscriber Line Interface Circuitry Line Driver

(76) Inventor: Douglas R. Frey, Bethlehem, PA (US)

(21) Appl. No.: 12/828,246

(22) Filed: Jun. 30, 2010

(51) Int. Cl. H04M 1/00

(52) U.S. Cl. 379/413.02

(57) ABSTRACT

A linefeed driver apparatus includes a first current mirror having an input leg for current I_{IN1} and a mirrored leg for current I_{MIRR1}, wherein I_{MIRR1} varies proportionately to I_{IN1} with a gain of α₁. The input leg and the mirrored leg of the first current mirror are coupled to provide (α₁+1)I_{IN1} to a driven line. The apparatus includes a second current mirror having an input leg for current I_{IN2} and a mirrored leg for current I_{MIRR2}, wherein I_{MIRR2} varies proportionately to I_{IN2} with a gain of α₂. The mirrored leg of the second current mirror provides α₂I_{IN2} to the driven line, wherein α₂=α₁+1.

### TECHNICAL FIELD

The invention is directed toward subscriber line drivers.

### BACKGROUND

Subscriber line interface circuits are typically found in the central office exchange of a telecommunications network. A subscriber line interface circuit (SLIC) provides a communications interface between the digital switching network of a central office and an analog subscriber line. The analog subscriber line connects to subscriber equipment such as a telephone at a location remote from the central office exchange.

The analog subscriber line and subscriber equipment form a subscriber loop. The subscriber equipment interface requirements imposes a need for the SLIC to provide relatively high voltages and currents for control signaling (linefeed) with respect to the subscriber equipment on the subscriber loop. Voiceband communications are low voltage analog signals on the subscriber loop. Thus the SLIC must also detect and communicate using low voltage analog signals with respect to the interface with the subscriber equipment. The SLIC also transforms the low voltage analog signals into digital data for transmission to the digital network. For bi-directional communication, the SLIC must also transform digital data received from the digital network into low voltage analog signals for transmission to the subscriber equipment on the subscriber loop.

A low voltage integrated circuit is typically used in conjunction with a high voltage integrated circuit to provide the required signal processing while maintaining the capability to drive significant line loads at voltages exceeding 100 volts. One design relies upon communicating pull-up and pull-down control currents from the low voltage integrated circuit to the high voltage integrated circuit. The high voltage integrated circuit controls the subscriber line in accordance with the control signals.

In order to save power and minimize the burden on the low voltage integrated circuit, the low voltage integrated circuit supplies currents significantly smaller than the actual line currents to the high voltage integrated circuit. The high voltage integrated circuit scales these currents up to the necessary levels. In conventional high voltage linefeed drivers the scaling function is accomplished via an arrangement of pull-up and pull-down amplifying current mirrors.

The use of scaling pull-up and pull-down current mirrors is an efficient way drive the line. However, the system constraints on longitudinal balance (common mode rejection ratio) dictate high accuracy with respect to current amplification. Furthermore, stability requirements of the metallic (differential) loop necessitate a wide bandwidth. Other important design constraints relate to noise, offset, and clipping headroom at full output current.

One prior art implementation of pull-up and pull-down current mirrors relies upon high voltage NMOS and PMOS devices. In modern high voltage CMOS processes, the PMOS devices are much larger than the NMOS devices, given that they are sized to yield the same electrical properties, such as Rₒₙ. The larger devices are potentially slower since the gate capacitance of the PMOS device is larger than that of the respective NMOS device. As a result, existing circuit solutions for the driver require more area and have potentially lower bandwidth due to the need for large geometry PMOS devices in the signal path.

### SUMMARY

A linefeed driver apparatus includes a first current mirror having an input leg for current I_{IN1} and a mirrored leg for current I_{MIRR1} wherein I_{MIRR1} varies proportionately to I_{IN1} with a gain of α₁. The input leg and the mirrored leg of the first current mirror are coupled to provide (α₁+1)I_{IN1} to a driven line. A second current mirror having an input leg for current I_{IN2} and a mirrored leg for current I_{MIRR2}, wherein I_{MIRR2} varies proportionately to I_{IN2} with a gain of α₂. The mirrored leg of the second current mirror provides α₂I₂ to the driven line, wherein α₂=α₁+1.

Other features and advantages of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates one embodiment of a plain old telephone system (POTS) communication architecture.

FIG. 2 illustrates one embodiment of a subscriber line interface circuit utilized with POTS lines.

FIG. 3 illustrates one embodiment of a prior art linefeed driver with current mirrors.

FIG. 4 illustrates one embodiment of a prior art current mirror.

FIG. 5 illustrates one embodiment of a two stage current mirror.

FIG. 6 illustrates one embodiment of an improved pull-up, pull-down current mirror arrangement using transistors of one polarity in the signal paths.

FIG. 7 illustrates one embodiment of a current mirror apparatus for providing the functionality of a current mirror and a differential pair.

FIG. 8 illustrates an alternative embodiment of a current mirror apparatus for providing the functionality of a current mirror and differential pair.

### DETAILED DESCRIPTION

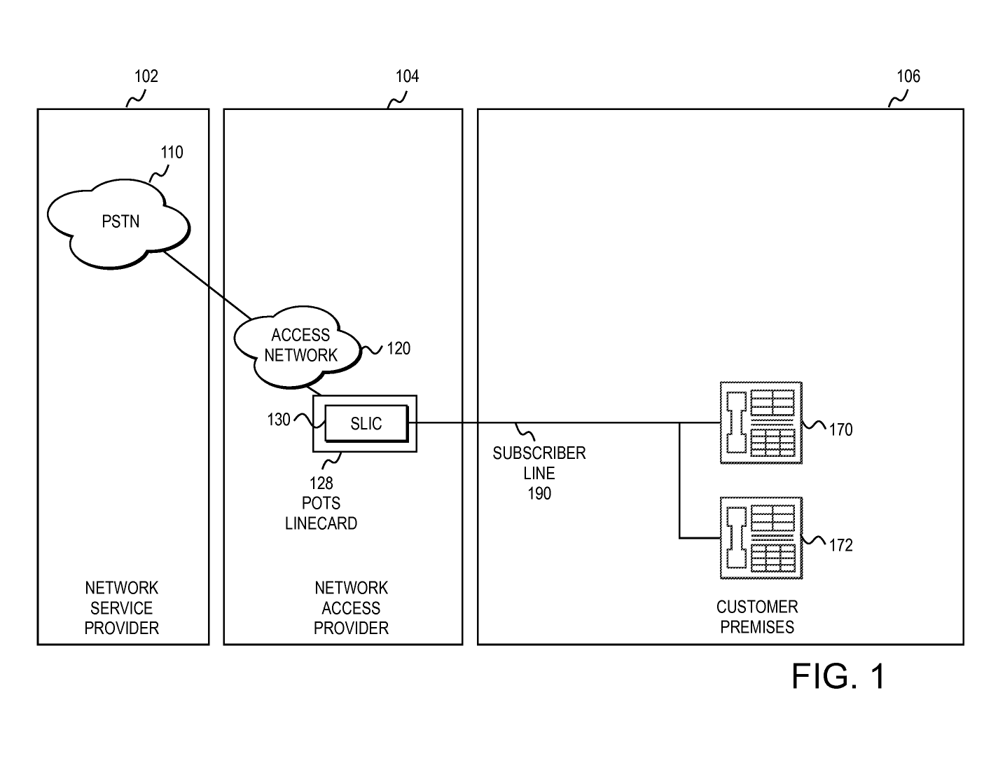

FIG. 1 illustrates one embodiment of a prior art communications network model supporting voiceband communications associated with plain old telephone services (POTS) telephone system. The network model is divided into three physical domains: network service provider(s) 102, network access providers 104, and customer premises 106.

The network service providers (NSP) may have networks that span large geographic areas. Typically, however, the customer premises (CP) must be located within a specified distance of the network access provider (NAP) as a result of electrical specifications on the subscriber line 190. Thus network access providers typically have a number of central offices (CO) that support customers within a specified radius. Local exchange carriers (LEC) and competitive local exchange carriers (CLEC) are examples of network access providers.

In one embodiment, the network access provider is a telephone company. Subscriber equipment (i.e., customer premises equipment such as telephones 170, 172) is connected to a central office (CO) of the network access provider 104 via a subscriber line 190. For POTS systems, the subscriber line includes a tip line and a ring line that are typically implemented as an unshielded twisted copper wire pair.

The central office has numerous POTS linecards 128 for supporting multiple subscriber lines. Each linecard has at least one subscriber line interface circuit (SLIC) 130 that serves as an interface between a digital switching access network 120 of a local telephone company central office and the subscriber equipment 170, 172. In some embodiments, each linecard has a plurality of SLICs. The access network provides the SLIC and associated subscriber with access to the PSTN 110 for bi-directional communication with other subscribers similarly coupled to the PSTN.

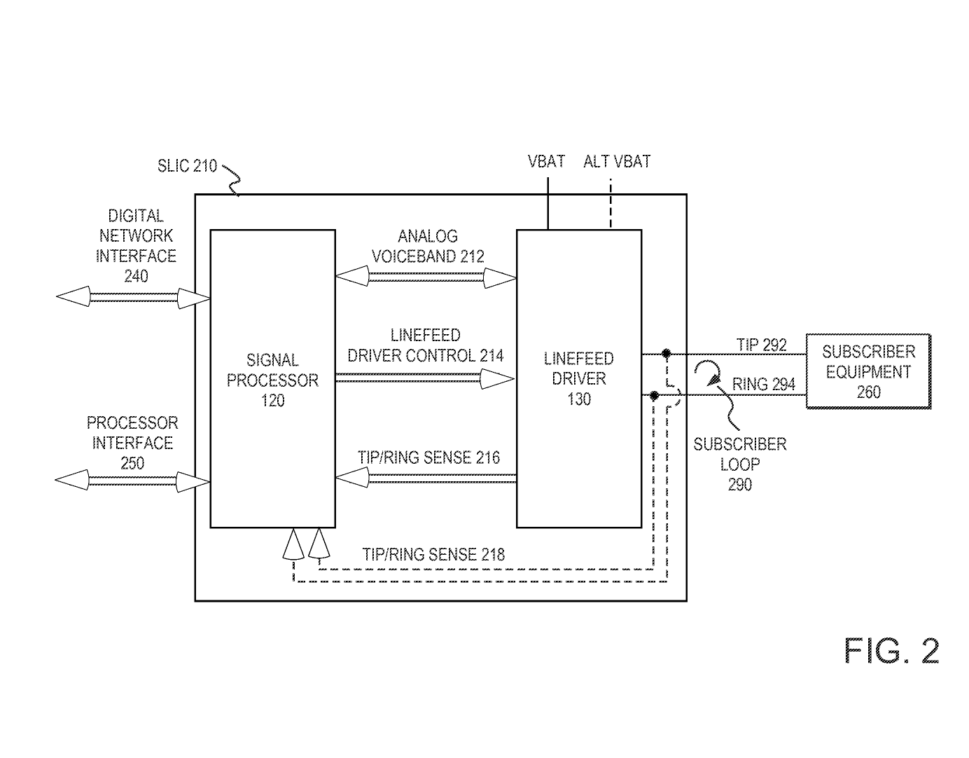

FIG. 2 illustrates one embodiment of a SLIC 210 associated with POTS lines. The SLIC provides an interface between a digital switching network of a local telephone company central exchange and a subscriber line comprising a tip 292 and a ring 294 line. A subscriber loop 290 is formed when the subscriber line is coupled to subscriber equipment 260 such as a telephone.

The subscriber loop 290 communicates analog data signals (e.g., voiceband communications) as well as subscriber loop “handshaking” or control signals. The subscriber loop state is often specified in terms of the tip 292 and ring 294 portions of the subscriber loop.

The SLIC is typically expected to perform a number of functions often collectively referred to as the BORSCHT requirements. BORSCHT is an acronym for “battery feed,” “overvoltage protection,” “ringing,” “supervision,” “codec,” “hybrid,” and “test.” The term “linefeed” will be used interchangeably with “battery feed”. Modern SLICs may have battery backup, but the supply to the subscriber line is typically not actually provided by a battery despite the retention of the term “battery” to describe the supply (e.g., VBAT).

The ringing function, for example, enables the SLIC to signal the subscriber equipment 260. In one embodiment, subscriber equipment 260 is a telephone. Thus, the ringing function enables the SLIC to ring the telephone.

In the illustrated embodiment, the BORSCHT functions are distributed between a signal processor 220 and a linefeed driver 230. The signal processor and linefeed driver typically reside on a linecard (210) to facilitate installation, maintenance, and repair at a central exchange. Signal processor 220 is responsible for at least the ringing control, supervision, codec, and hybrid functions. Signal processor 220 controls and interprets the large signal subscriber loop control signals as well as handling the small signal analog voiceband data and the digital voiceband data.

In one embodiment, signal processor 220 is an integrated circuit. The integrated circuit includes sense inputs for both a sensed tip and a sensed ring signal of the subscriber loop. The integrated circuit generates subscriber loop linefeed driver control signal in response to the sensed signals. The signal processor has relatively low power requirements and can be implemented in a low voltage integrated circuit operating in the range of approximately 5 volts or less. In one embodiment, the signal processor is fabricated as a complementary metal oxide semiconductor (CMOS) integrated circuit.

Signal processor 220 receives subscriber loop state information from linefeed driver 230 as indicated by tip/ring sense 216. The signal processor may alternatively directly sense the tip and ring as indicated by tip/ring sense 218. This information is used to generate linefeed driver control 214 signals for linefeed driver 230. Analog voiceband 212 data is bi-directionally communicated between linefeed driver 230 and signal processor 220. In an alternative embodiment, analog voiceband signals are communicated downstream to the subscriber equipment via the linefeed driver but upstream analog voiceband signals are extracted from the tip/ring sense 218.

SLIC 210 includes a digital network interface 240 for communicating digitized voiceband data to the digital switching network of the public switched telephone network (PSTN). The SLIC may also include a processor interface 250 to enable programmatic control of the signal processor 220. The processor interface effectively enables programmatic or dynamic control of battery control, battery feed state control, voiceband data amplification and level shifting, longitudinal balance, ringing currents, and other subscriber loop control parameters as well as setting thresholds including ring trip detection and off-hook detection threshold.

Linefeed driver 230 maintains responsibility for battery feed to tip 292 and ring 294. The battery feed and supervision circuitry typically operate in the range of 40-75 volts. The battery feed is negative with respect to ground, however. Moreover, although there may be some crossover, the maximum and minimum voltages utilized in the operation of the battery feed and supervision circuitry (−48 or less to 0 volts) tend to define a range that is substantially distinct from the operational range of the signal processor (e.g., 0-5 volts). In some implementations the ringing function is handled by the same circuitry as the battery feed and supervision circuitry. In other implementations, the ringing function is performed by separate higher voltage ringing circuitry (75-150 Vᵣₘₛ).

Linefeed driver 230 modifies the large signal tip and ring operating conditions in response to linefeed driver control 214 provided by signal processor 220. This arrangement enables the signal processor to perform processing as needed to handle the majority of the BORSCHT functions. For example, the supervisory functions of ring trip, ground key, and off-hook detection can be determined by signal processor 220 based on operating parameters provided by tip/ring sense 216.

The linefeed driver receives a linefeed supply VBAT for driving the subscriber line for SLIC “on-hook” and “off-hook” operational states. An alternate linefeed supply (ALT VBAT) may be provided to handle the higher voltage levels (75-150 Vrms) associated with ringing.

The SLIC signal processor 220 is typically a low voltage integrated circuit and the linefeed driver 230 is a high voltage integrated circuit. The supply voltage for the low voltage integrated circuit is typically in a range of zero (ground) to 3.3 volts. If the linefeed driver is handling ringing, then the supply voltage for the high voltage integrated circuit (i.e., VBAT) may be −80 volts or more.

The signal processor sends pull-up and pull-down control current signals into substantially ground-referenced input nodes of the linefeed driver. In order to save power and minimize the burden on the signal processor, linefeed driver control currents significantly smaller than the actual subscriber line currents are supplied to the linefeed driver. The linefeed driver scales the control currents to the appropriate levels that typically range from approximately 500 μA to 50 mA or more. A typical scale factor might be ×50 such that the signal processor is only required to source from about 10 μA to 1 mA.

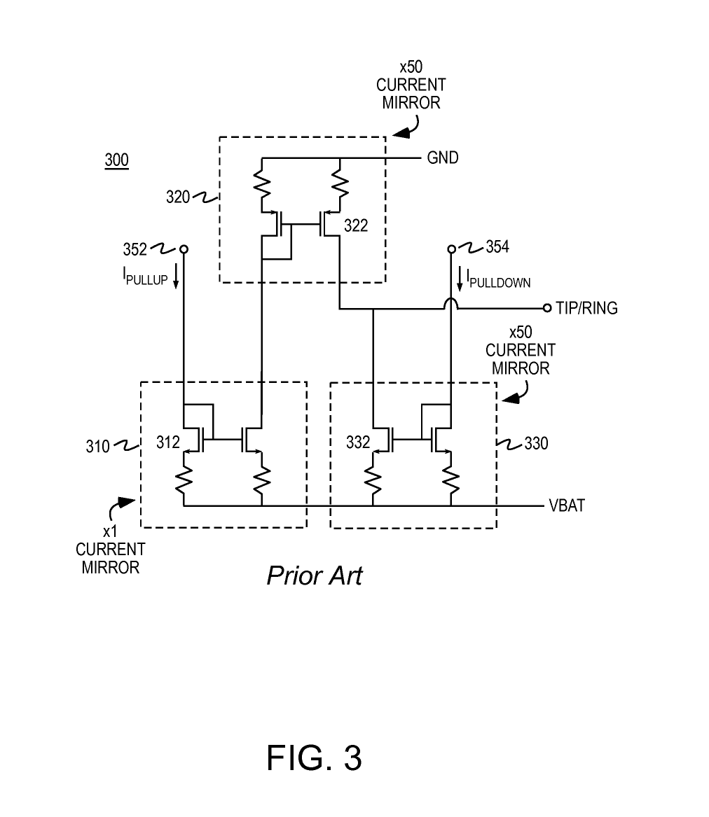

In order for the linefeed driver to achieve the necessary gain it must provide the function of a ×50 current amplifier for both a pull-up control current and a pull-down control current, thereby allowing the linefeed driver to source or sink current from the tip and ring sides of the line. In conventional high voltage line drivers these functions are accomplished via an arrangement of amplifying current mirrors 300, such as illustrated in FIG. 3.

In particular, pull-up and pull-down control currents from the signal processor may be applied at nodes 352 and 354, respectively. Current mirror 310 utilizes a ×1 scale and current mirrors 320, 330 are ×50 current amplifiers.

The system constraints on longitudinal balance (common mode rejection ratio) dictate that the accuracy of the current amplification be on the order of 0.1%. Furthermore, stability requirements of the metallic (differential) loop necessitate a bandwidth in excess of 100 KHz under all operating conditions. Other important design constraints relate to noise, offset, and clipping headroom at full output current.

The current mirrors of FIG. 3 comprise N-channel and P-channel insulated gate field effect transistors such as n-channel metal oxide semiconductor (NMOS) or p-channel metal oxide semiconductor (PMOS) field effect transistors. Due to the difference between VBAT and ground, the current mirrors of FIG. 3 require high voltage NMOS 312, 332 and high voltage PMOS 322 devices to implement the pull-down and pull-up mirrors, respectively.

In modern high voltage CMOS processes, the PMOS devices are much larger than the NMOS devices to yield comparable electrical properties, such as R_{ON}. This tends to make the pull-up current mirror circuitry much larger. Given that gate capacitance is related to device size, the gate capacitance of the PMOS device in the pull-up mirror will be necessarily larger than that of the respective NMOS device in the pull-down mirror. Due to the larger gate capacitance, the PMOS devices are potentially slower to respond than the NMOS devices. As a result, the prior art solution for the driver requires more area and has potentially lower bandwidth due to the need for large geometry PMOS devices in the signal path. In various embodiments, the current mirrors are implemented as integrated circuit current mirrors.

Currents on the order of approximately 50 mA are considered to be high currents for integrated circuits. The current mirror output devices are high voltage devices due to subscriber line operating ranges. One constraint for the design of high voltage, high current integrated circuit current mirrors for subscriber line application is that accuracy and bandwidth must be maintained over a current range spanning approximately two orders of magnitude.

Due to inherent device-to-device mismatches that occur in threshold voltage and transconductance, implementations without appropriate degeneration are generally not practical. The mismatches result in unacceptable distortion to the desired linear transfer characteristic of the current mirror over a wide operating current range. Accordingly, the current mirror transistors are typically degenerated with small-ratioed resistors. Due to random mismatch between the transistor and resistor pairs, this often yields an unacceptably high deviation from linearity of the transfer characteristic.

One approach to improving linearity is to introduce a high gain amplifier to sense the voltage across the degeneration resistors. This approach forces mirror accuracy to rely primarily upon resistor matching. The resistors must be kept small to avoid significant losses when carrying a large output current. Thus the sensed voltage tends to be very small for most operating conditions. Accordingly, a high gain amplifier for a system having a variable loop gain is desired.

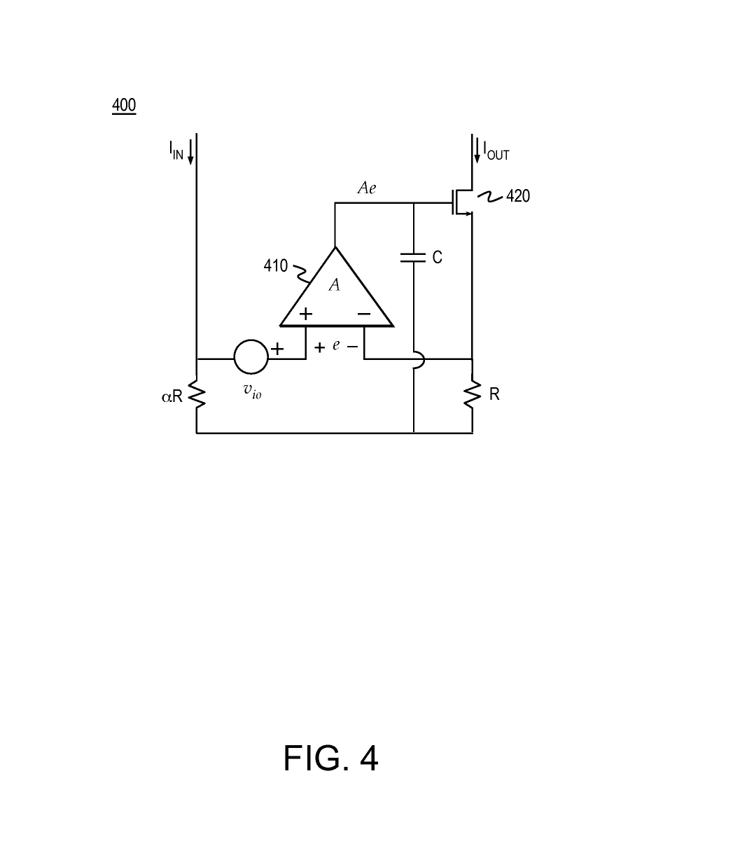

FIG. 4 illustrates one embodiment of a high gain current mirror 400 for purposes of analysis. The high gain amplification is modeled as operational amplifier 410. The operational amplifier has a frequency dependent gain, A for its input differential voltage, e such that the output of the high gain amplifier is Ae. The input offset voltage of the operational amplifier is modeled as a voltage source, vᵢₒ.

The current mirror processes input current I_{IN} and provides an output current of approximately αI_{IN} with a proportional error of δ. The error is the result of non-idealities associated with the amplifier and the output transistor. There is also a fixed offset current, I_{OFF}, in the output current due to the input referred offset of the operational amplifier 510.

For a typical driver design, α=50. For the full range of output currents (approximately 500 μA to 50 mA, the driver is designed to provide δ<0.002. In addition, the current mirror must support a small signal bandwidth of at least 100 KHz.

The transfer characteristic from the input to the output of the current mirror is as follows:

$$\begin{matrix}{I}_{OUT} = {I}_{OFF} + ( 1 + δ ) α {I}_{IN} \\ = \frac{{g}_{m} RA}{{g}_{m} R ( A + 1 ) + 1} ( α {I}_{IN} + \frac{{v}_{io}}{R} )\end{matrix}$$

$$where$$

$${I}_{OFF} \approx \frac{{v}_{io}}{R} ; and δ \approx - \frac{1}{{g}_{m} RA} for {g}_{m} RA >> 1$$

The gain A is independent of the output current, I_{OUT}. The transconductance gₘ of the output transistor 420, however, is dependent upon output current and temperature. The transconductance might change by a factor of 25 during typical operating conditions. Thus δ is a strong function of the output current and temperature. The loop gain, gₘRA must be sufficient to maintain adequate longitudinal balance for worst case subscriber line conditions.

The loop gain also determines the 3 dB bandwidth of the current mirror. The 3 dB point is approximated as the frequency at which the loop gain is one. In order to maintain adequate bandwidth over all operating conditions, one must ensure that the loop gain is adequate for the worst case. This causes the loop gain to be approximately 25 times larger under the highest transconductance scenario. Due to secondary poles in the operational amplifier 410 and transistor 420 loop, this level of loop gain can result in system instabilities.

To reduce the likelihood of system instability, the secondary poles may be suppressed or offset using a capacitance such as the gate capacitance of the output transistor to create a dominant pole. The gate capacitance of transistor 420 is modeled as capacitor, C. This capacitance is relatively large due to the size of the output device and is certain to create a significant secondary pole if it is not the dominant pole. One design approach is to utilize a two stage amplifier design with a high transconductance input stage.

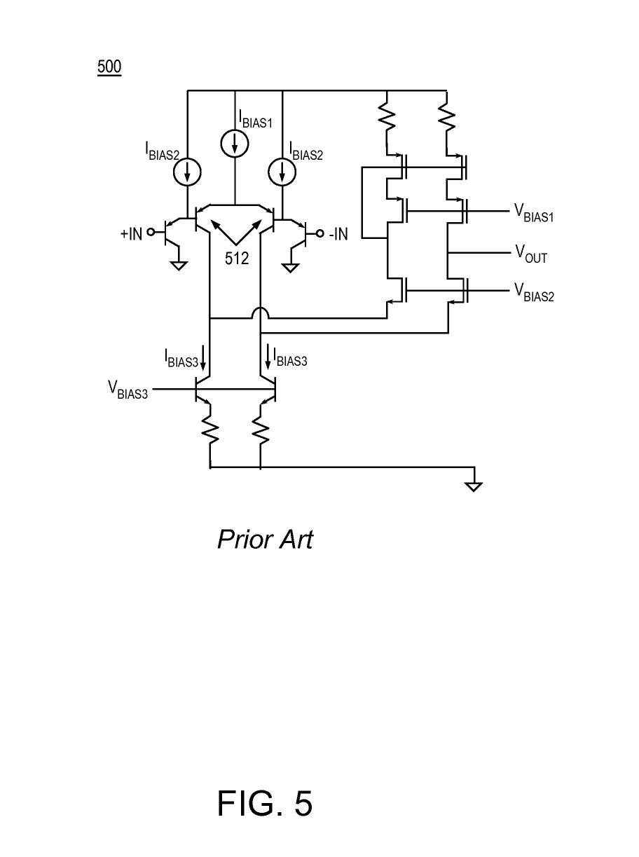

FIG. 5 illustrates one embodiment of a two stage high gain current mirror 510. An input differential Darlington pair 520 receives a differential input 522 with a common mode range including the negative supply rail. Transistors 512 are coupled in a folded cascode configuration to enable the proper operation of the front end at the negative rail and also serve to increase the impedance of the output. The net AC signal transconductance gain from the input to the output is determined primarily by the tail current bias, IBIAS. The AC signal transconductance gain is approximately

$$\frac{{I}_{BIAS 1}}{2 {V}_{T}}$$

where V_{T} is the thermal voltage for the input transistors.

One advantage of this circuit is that it provides as much gain as possible for the applied tail current. In addition, the input noise is low due to the high transconductance of the bipolar transistors and the fact that the 1/f noise is typically better for bipolar junction transistors than for CMOS devices.

A drawback of the circuit is that the current consumption is considerably greater than the tail current. Additional circuitry is also required to create the bias voltages thus adding to the complexity and current demands of the amplifier. The presence of additional internal nodes also adds to the possibility of additional secondary poles.

Referring to FIGS. 3 and 5, drawbacks to prior art current mirror architecture include i) the use of both NMOS and PMOS devices in the signal paths of the pull-up and pull-down drivers; and ii) the current consumption or complexity of the current mirrors.

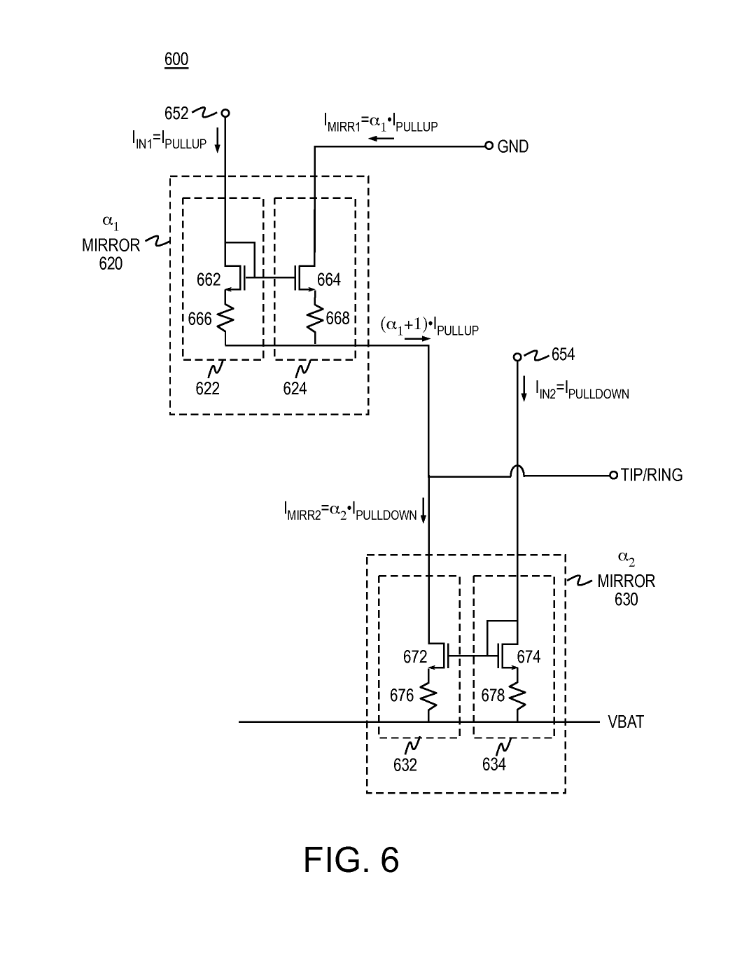

FIG. 6 illustrates one embodiment of an improved pull-up, pull-down current mirror arrangement 600 using transistors of one polarity in the signal paths. The current mirror arrangement includes a first current mirror (620) and a second current mirror (660). Given that VBAT <0 (i.e., ground), the first current mirror is a pull-up driver. The second current mirror is a pull-down driver.

In the illustrated embodiment, a first current mirror 620 includes an input leg 622 for a current I_{IN1} and a mirrored leg 624 for current I_{MIRR1} that varies proportionately to I_{IN1} with a gain of α₁. The input leg and mirrored leg of the first current mirror are coupled to provide the current (α₁+1)I_{IN1} to a driven line. The pull-up driver thus relies upon the fact that the total current leaving the current mirror and provided to the driven line is (I_{IN1}+I_{MIRR1}). In one embodiment, the driven line is one of a tip and a ring line of a subscriber line.

The second current mirror 630 includes an input leg 632 for a current I_{IN2} and a mirrored leg 634 for current I_{MIRR2} that varies proportionately to I_{IN2} with a gain of α₂. The second current mirror is coupled to provide the current I_{MIRR2}=α₂I_{IN2} to the driven line. In one embodiment, α₂=α₁+1.

The input and mirror legs of both current mirrors comprise the same polarity active device. In the illustrated embodiment, N-channel insulated gate field effect transistors 662, 664, 672, 674 (e.g., metal oxide semiconductor field effect transistors) are used. Although an insulated gate transistor is depicted, the current mirrors may be architected for bipolar junction transistor or other active devices. In addition, the current mirrors may utilize devices of a different polarity such as P-channel or P-type transistors if the relationship between VBAT and ground is changed. The current mirror circuitry includes degeneration resistors 666, 668, 676, and 678.

When a pull-up current Iₚᵤₗₗᵤₚ is applied as I_{IN1} to node 652, a ground sourced current (α₁+1)I_{PULLUP} is provided to the tip or ring line. When a pull-down current I_{PULLDOWN} is applied as I_{IN2}, to node 654, a VBAT sourced current α₂I_{PULLDOWN} is provided to the tip or ring line. There is no asymmetry in effect of I_{PULLUP} or I_{PULLDOWN} on the driven line, however, because α₂=α₁+1. In one embodiment, α₁≈49 and α₂≈50. In various embodiments α₂≧50 or

$$\frac{{α}_{1}}{{α}_{2}} \geq 0.98 .$$

Thus in contrast with the prior art circuitry 300 of FIG. 3, this embodiment is capable of achieving the same net gain (i.e., for the control currents, I_{PULLUP} and I_{PULLDOWN}) utilizing only devices of one polarity in the signal path. Given the disparity in size for P-channel and N-channel devices, this approach can provide the gain functionality utilizing less area when fabricated and with an improved bandwidth to the extent that the bandwidth is determined by the size of the gate capacitance of the output transistors in the respective mirrors.

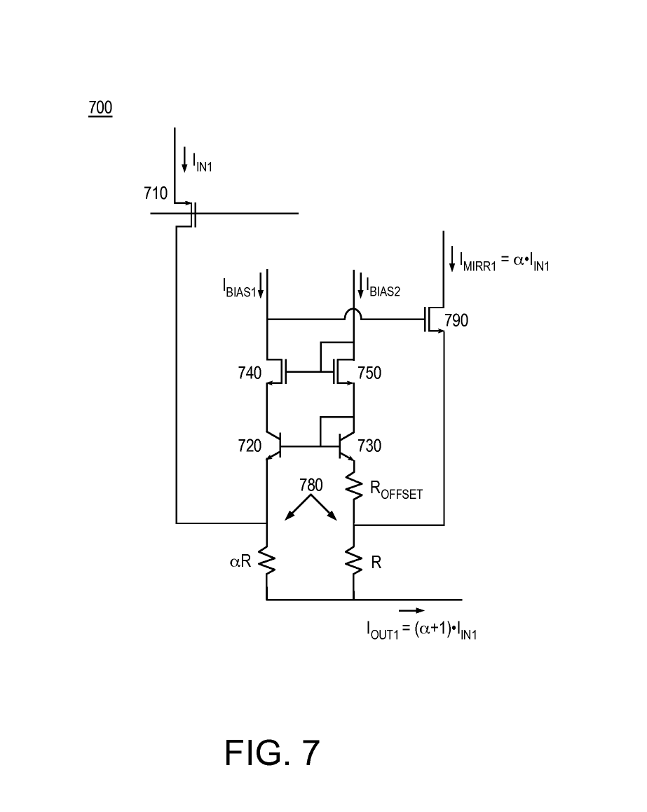

FIG. 7 illustrates one embodiment of a current mirror apparatus to provide the functionality of a current mirror and a differential pair. The illustrated circuit includes the high voltage pass transistor 790 that the amplifier is designed to drive.

The amplifier transistors 720-750 are connected as a cascoded current mirror processing bias currents, I_{BIAS1} and I_{BIAS2}. A differential input 780 is introduced into the degeneration resistor network. Transistors 720-730 form a translinear loop of transistors. The gain of the amplifier depends upon the dynamic resistance of these transistors in series with the resistance on each side. The translinear loop of transistors provides an amplifier gain to aid in controlling the accuracy of the current mirror.

The current mirror is balanced by matching the degeneration resistors in each leg such that αR=R+R_{OFFSET}. However, by dividing the degeneration resistance in one leg into two parts (i.e., R, R_{OFFSET}) one can compare currents with any ratio to create equal voltages by appropriately scaling the resistors R and αR.

The differential voltage resulting from currents not being in the correct α:1 ratio is effectively applied across the base-emitter junction of transistor 720 and degeneration resistor, αR. This is due to a constant bias current flowing through transistor 730 and R_{OFFSET}. The transconductance gain from this differential voltage to the signal current leaving the drain of transistor 750 is identical to that produced by a differential pair degenerated by resistors of value αR whose tail current equals the sum of I_{BIAS1} and I_{BIAS2}. As a result the voltage gain of the amplifier is this transconductance times the net impedance at the gate of the pass transistor, 790.

By cascoding the current mirror with transistors 740, 750, the voltage gain can be made high at lower frequencies. Furthermore, the gate capacitance of 790 directly leads to the dominant pole in the loop comprising the amplifier and the pass transistor. Given that the dynamic impedance of the transistor, 720, is generally larger than the resistor value, αR, for typical bias currents, the gain of this amplifier circuit substantially matches that of the prior art amplifier 500 of FIG. 5 but does so with fewer components and less bias current.

Some applications may require a higher gain than is available from the circuit of FIG. 7 using small bias current values. The gain is determined substantially by the dynamic impedance of transistor 720 in series with resistance αR. Thus the gain for lower bias currents is limited by the dynamic impedance of the base-emitter junction of transistor 720. The gain varies with process and temperature however. The ratio of αR and R (i.e., α) establishes the current mirror gain for an infinite amplifier gain. However, the amplifier gain is finite and thus the current mirror gain is not determined solely by α. Given a longitudinal balance requirement of 0.1 percent accuracy, the degradation due to process and temperature can be problematic with respect to establishing and maintaining the longitudinal balance requirements.

For example, using 5 μA for the bias current, the dynamic resistance presented by transistor 720 is approximately 5000Ω at room temperature. The dynamic resistance may be too large for the desired transconductance. In addition, the dynamic resistance varies with the absolute temperature such that the amplifier transconductance is dependent upon temperature. Preferably the gain should be determined by a resistor the value of which may be selected to be smaller than the dynamic impedance of a transistor junction biased at a desirable current level.

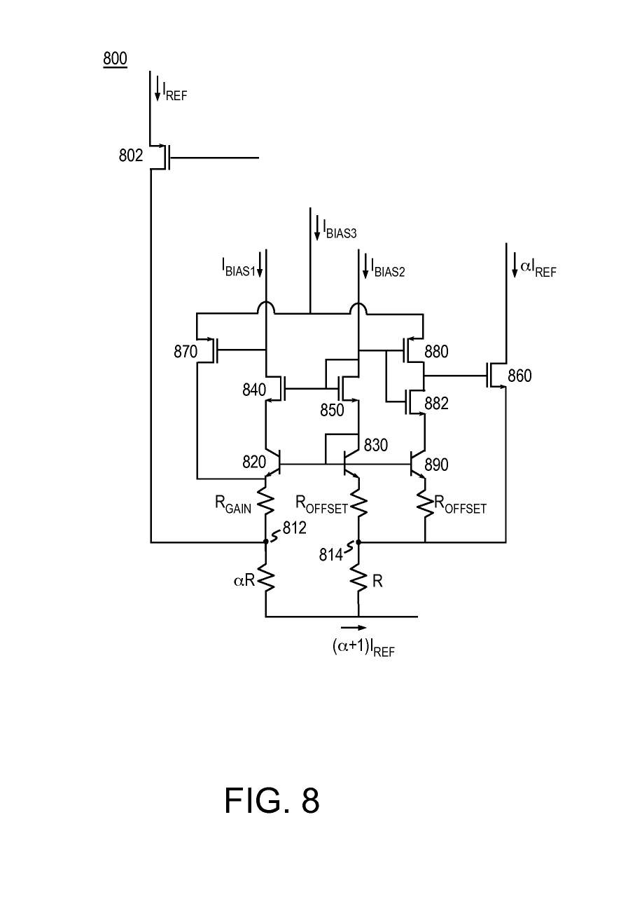

FIG. 8 illustrates an alternative embodiment of a current mirror apparatus for providing the functionality of a current mirror and differential pair. The amplifier gain circuit has been enhanced via the differential pair comprising transistors 870 and 880. These transistors force the current in 820 and 840 to remain constant and equal to I_{BIAS1}. The signal current in 870 must vary to match any signal current flowing through R_{GAIN}. The current in 830 is constant so signal variations at node 814 are directly applied to the base of transistor 820. However, the current through transistor 820 is being held constant, so signal variations at node 814 are directly applied to the top of R_{GAIN}. Consequently, a voltage signal appearing between nodes 812 and 814 is forced across R_{GAIN}, such that the current in transistor 870 is that voltage signal divided by R_{GAIN}.

The constant tail current applied to the transistor pair 870, 880 ensures that transistor 880 carries an equal and opposite current as that flowing in 870. Hence, the current leaving the drain of 870 is

$$\frac{1}{{R}_{GAIN}}$$

times the signal voltage appearing between nodes 812 and 814. This transconductance is substantially independent of temperature changes if the temperature coefficient of the resistor R_{GAIN} is small.

A copy of the fixed current flowing in transistor 820 is produced by transistor 890 with its cascode transistor 882. Transistor 880 does not require cascoding to ensure high output impedance because of the high impedance at the drain of transistor 840. The net result is that the signal developed at the gate of the output transistor 860 is essentially a fixed transconductance times the impedance at the gate of transistor 860.

The circuitry of FIG. 8 mitigates the limitations of the circuitry of FIG. 7 with the additional gain stage formed by transistors 870, 880. The gain of the amplifier is dependent upon the R_{GAIN} resistor value rather than the dynamic impedance of transistors 820 and 830 (which are analogous to transistors 720, 730 of FIG. 7). If R_{GAIN} is sufficiently small, the amplifier portion of FIG. 8 will achieve a greater gain than the amplifier portion of FIG. 7. The amplifier gain of FIG. 8 is also less dependent upon temperature and process variations than the amplifier gain of FIG. 7. Thus the current mirror gain is more accurately determined by the resistor ratio of αR and R (i.e., α).

The current mirror of FIG. 8 may be substituted for the current mirrors of FIG. 6 for pull-up, pull-down control of the driven line. Each current mirror incorporates active circuitry utilizing a resistor to control gain of the active circuitry, wherein the active circuitry controls accuracy of that mirror.

In one embodiment, typical values for the resistors are as follows: R_{GAIN}≈2kΩ; R_{OFFSET}≈R_{GAIN}+αR≈2.72kΩ; R≈15Ω; and α≈49-50. The value of α determines the value selected for αR.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A linefeed driver apparatus, comprising:
a first current mirror having an input leg for current I_{IN1} and a mirrored leg for current I_{MIRR1}, wherein I_{MIRR1} varies proportionately to I_{IN1} with a gain of α₁, wherein the input leg and the mirrored leg of the first current mirror are coupled to provide (α₁+1)I_{IN1} to a driven line; and
a second current mirror having an input leg for current I_{IN2} and a mirrored leg for current I_{MIRR2}, wherein I_{MIRR2} varies proportionately to I_{IN2} with a gain of α₂, wherein the mirrored leg of the second current mirror provides α₂I_{IN2} to the driven line, wherein α₂=α₁+1.

2. The apparatus of claim 1 wherein the input leg and the mirrored leg of each of the first and second current mirrors comprises a transistor of a first polarity.

3. The apparatus of claim 2 wherein the first polarity is N-type.

4. The apparatus of claim 2 wherein the first polarity is P-type.

5. The apparatus of claim 2 wherein the transistor is an insulated gate field effect transistor.

6. The apparatus of claim 1 wherein
$$\frac{{α}_{1}}{{α}_{2}} \geq 0.98 .$$

7. The apparatus of claim 1 wherein α₂≧50.

8. The apparatus of claim 1 wherein the mirrored leg of the first current mirror is coupled to ground, wherein the mirrored leg of the second current mirror is coupled to a voltage source VBAT, wherein VBAT is less than ground such that I_{IN1} is a pull-up control for the driven line, wherein I_{IN2} is a pull-down control for the driven line.

9. The apparatus of claim 1 wherein the mirrored leg of the first current mirror is coupled to ground, wherein the mirrored leg of the second current mirror is coupled to a voltage source VBAT, wherein VBAT is greater than ground such that I_{IN1} is a pull-down control for the driven line, wherein I_{IN2} is a pull-up control for the driven line.

10. The apparatus of claim 1 wherein the driven line is one of a tip line and a ring line of a subscriber line.

11. The apparatus of claim 1 wherein the first and second mirrors are fabricated on a semiconductor die of an integrated circuit.

12. The apparatus of claim 1 wherein each of the first and second current mirrors comprises a translinear loop of transistors to control accuracy of that mirror.

13. The apparatus of claim 12 further comprising active circuitry utilizing a resistor to control gain of the active circuitry, wherein the active circuitry controls accuracy of that mirror.
